(19) United States
(12) Patent Application Publication
(10) Pub. No.: US 2022/0142330 A1
(43) Pub. Date: May 12, 2022

(54) GEL NAIL STICKER

(71) Applicant: Mingxuan Zhang, Dongguan (CN)

(72) Inventor: Mingxuan Zhang, Dongguan (CN)

(21) Appl. No.: 17/452,768

(22) Filed: Oct. 28, 2021

(30) Foreign Application Priority Data
Nov. 11, 2020 (CN) 202011253747.X

(51) Int. Cl. A45D 31/00; A45D 29/00; B05D 7/00

(52) U.S. Cl. CPC A45D 31/00; B05D 7/584; A45D 29/001

(57) ABSTRACT

A gel nail sticker includes a bottom layer, a color layer arranged on the bottom layer, a bronzing primer layer arranged on the color layer, a brightening layer arranged on the bronzing primer layer, and a protective film arranged on the brightening layer. The bottom layer adopts a self-adhesive layer with strong adhesion, flexibility, deformability, and stretchability. The color layer is printed in different colors depending on the needs of the product. The first varnish layer and second varnish layer protect the color layer. The bronzing primer layer is used to make the surface of the nail sticker display a shimmering effect. The bronzing film protects the bronzing primer layer. The protective film is used to prevent scratches on the surface of the nail sticker. By setting the color layer, bronzing primer layer and brightening layer, the nail sticker can present a more beautiful effect.

### CROSS-REFERENCE TO RELATED APPLICATIONS

This is a U.S. patent application which claims the priority and benefit of Chinese patent application number 202011253747.X, filed on Nov. 11, 2020, the disclosure of which is incorporated herein by reference in its entirety.

### TECHNICAL FIELD

The present disclosure relates to the technical field of nail stickers, and more particularly relates to a gel nail sticker.

### BACKGROUND

Nail stickers are a kind of nail decoration that is quite popular among young women in recent years. They are an indispensable item for nail art lovers, and have unique use methods and special effects that cannot be replaced by other nail art tools.

### SUMMARY

In order to overcome the above-mentioned deficiencies, the present disclosure aims to provide a technical solution that can solve the above-mentioned problems.

A gel nail sticker includes a bottom layer, where a color layer is disposed on the bottom layer, a bronzing primer layer is disposed on the color layer, a brightening layer is disposed on the bronzing primer layer, and a protective film is disposed on the brightening layer.

In one embodiment, the bottom layer is a self-adhesive layer.

In one embodiment, a first varnish layer and a second varnish layer are respectively disposed on an upper and a lower end surface of the color layer.

In one embodiment, a bronzing film is further arranged between the bronzing primer layer and the brightening layer.

In one embodiment, a dual-curing varnish layer is further arranged between the brightening layer and the protective film.

Compared with the related art, the present disclosure provides the following beneficial effects.

The bottom layer adopts a self-adhesive layer with strong adhesion, flexibility, deformability, and stretchability. The color layer is printed in different colors depending on the needs of the product. The first varnish layer and the second varnish layer protect the color layer. The bronzing primer layer is used to make the surface of the nail sticker display a shimmering effect. The bronzing film protects the bronzing primer layer. The brightening layer makes the nail sticker surface bright. The dual-curing varnish layer protects the brightening layer. The protective film is used to prevent scratches on the surface of the nail sticker. By setting the color layer, bronzing primer layer and brightening layer, the nail sticker can present a more beautiful effect.

Additional aspects and advantages of the present disclosure will be partly given in the following description, and part of them will become obvious from the following description, or be understood through the practice of the present disclosure.

### BRIEF DESCRIPTION OF DRAWINGS

For a clearer understanding of the technical solutions that are used in the embodiments according to the present disclosure or that are used in the related art, hereinafter the drawings that are required for the description of the embodiments disclosed herein or the related art will be briefly introduced. Apparently, the drawings in the following description merely represent some embodiments of the present disclosure, and for those having ordinary skill in the art, other drawings may also be obtained based on these drawings without investing creative efforts.

FIG. 1 is a schematic diagram of the present disclosure.

### DETAILED DESCRIPTION OF ILLUSTRATIVE EMBODIMENTS

Hereinafter, technical solutions in the embodiments according to the present disclosure will be described in a definite and comprehensive manner. It is evident that the embodiments described herein are only a part, rather than all of the embodiments in accordance with the present disclosure. Based on the embodiments of the present disclosure, all other embodiments obtained by those having ordinary skill in the art without investing creative efforts shall all fall in the scope of protection of the present disclosure.

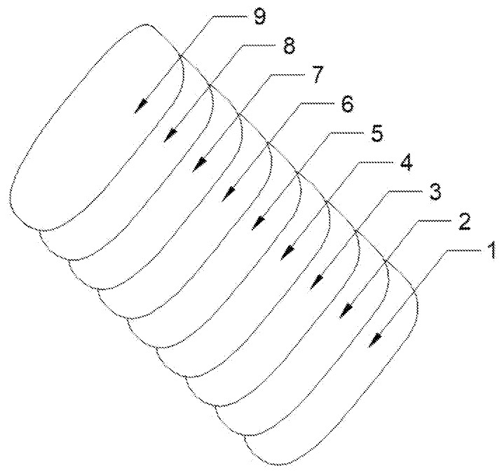

Referring to FIG. 1, in an embodiment of the present disclosure, a gel nail sticker includes a bottom layer 1, where a color layer 3 is disposed on the bottom layer 1, a bronzing primer layer 5 is disposed on the color layer 3, a brightening layer 7 is arranged on the bronzing primer layer 5, and a protective film 9 is arranged on the brightening layer 7.

Further, as illustrated in FIG. 1, the bottom layer 1 may be a self-adhesive layer.

Further as illustrated in FIG. 1, a first varnish layer 2 and a second varnish layer 4 may be respectively disposed on an upper and lower end surfaces of the color layer 3.

Further, as illustrated in FIG. 1, a bronzing film 6 may be further arranged between the bronzing primer layer 5 and the brightening layer 7.

Further, as illustrated in FIG. 1, a dual-curing varnish layer 8 may be further arranged between the brightening layer 7 and the protective film 9.

In the above-mentioned technical means, the bottom layer 1 adopts a self-adhesive layer with strong adhesion, flexibility, deformability, and stretchability. The color layer 3 is printed in different colors depending on the needs of the product. The first varnish layer 2 and the second varnish layer 4 protect the color layer. The bronzing primer layer 5 is used to make the surface of the nail sticker display a shimmering effect. The bronzing film 6 protects the bronzing primer layer 5. The brightening layer 7 makes the nail sticker surface bright. The dual-curing varnish layer 8 protects the brightening layer 7. The protective film 9 is used to prevent scratches on the surface of the nail sticker. By setting the color layer 3, bronzing primer layer 5 and the brightening layer 7, the nail sticker can present a more beautiful effect.

In order to further describe the effects of the above nail sticker, the present disclosure will further describe the manufacturing process of the following nail sticker.

More specifically, the bottom layer 1 is used to attach to the nail, and it is implemented as a self-adhesive layer. The self-adhesive layer has strong adhesion, flexibility, deformability, and stretchability, and so can be closely attached to the nail. The color layer 3 is printed in different colors depending on the needs of the product. Before overcoating the color layer 3, the first varnish layer 2 needs to be overlaid on the bottom layer 1. After the color layer 3 is overcoated, the second varnish layer 4 is further overcoated to cover the color layer 3 so as to protect the color layer 3 and effectively prevent fading. After the first varnish layer 2 and the second varnish layer 4 are coated, they may be dried for 6 hours by using a natural drying method to ensure that the first varnish layer 2 and the second varnish layer 4 are cured. After the color layer 3 is done, the bronzing primer layer 5 is coated and is cured by LED ultraviolet light, so that the surface of the nail sticker shows a flickering effect. After coating the bronzing base oil layer 5, the bronzing film 6 may be attached using a high temperature between 90 degrees and 110 degrees, typically 100 degrees. The bronzing film 6 adopts gold hot stamping, silver hot stamping, laser and various colors, which can not only protect the bronzing primer layer 5, but also improve the flickering effect. Immediately afterwards, a brightening layer 7 is attached to the bronzing film 6 to achieve a bright and beautiful effect. The brightening layer 7 is coated with a double-cured varnish layer 8, which is cured by one of natural drying or ultraviolet light curing, and which protects the brightening layer 7. After curing the dual-curing varnish layer 8, the gel nail sticker is stamped into a bracket shape by using a special-shaped knife mold. The gel nail sticker after molding is coated with a protective film 9 so that the surface of the nail sticker is not easy to be scratched. Finally, each piece of finished product is put into a black bag for sealed preservation.

For those skilled in the art, it is evident that the present disclosure will not be limited to the details of the foregoing exemplary embodiments, and the present disclosure can be implemented in other specific forms without departing from the spirit or basic characteristics of the present disclosure.

Therefore, from any point of view, the embodiments should be regarded as exemplary and non-restrictive. The scope of the present disclosure is defined in and by the appended claims rather than the above description, and therefore all changes falling within the meaning and scope of equivalent elements of the appended claims shall be included in the present disclosure.

What is claimed is:

1. A gel nail sticker, comprising:
a bottom layer;
a color layer, disposed on the bottom layer;
a bronzing primer layer, disposed on the color layer;
a brightening layer, disposed on the bronzing primer layer; and
a protective film, disposed on the brightening layer.

2. The gel nail sticker as recited in claim 1, wherein the bottom layer is a self-adhesive layer.

3. The gel nail sticker as recited in claim 1, wherein a first varnish layer and a second varnish layer are respectively arranged on an upper and a lower side of the color layer.

4. The gel nail sticker as recited in claim 1, wherein a bronzing film is further arranged between the bronzing primer layer and the brightening layer.

5. The gel nail sticker as recited in claim 1, wherein a dual-curing varnish layer is further arranged between the brightening layer and the protective film.
